(19) United States
(12) Patent Application Publication
(10) Pub. No.: US 2026/0001508 A1
(43) Pub. Date: Jan. 1, 2026

(54) SYSTEM AND METHOD FOR SMART SEAT BELT SYSTEM

(71) Applicant: Adalberto Valdovinos, Richardson, TX (US)

(72) Inventor: Adalberto Valdovinos, Richardson, TX (US)

(21) Appl. No.: 19/251,062

(22) Filed: Jun. 26, 2025

Related U.S. Application Data
(60) Provisional application No. 63/664,657, filed on Jun. 26, 2024.

(51) Int. Cl. B60R 22/20; B60N 2/68; B60R 22/26

(52) U.S. Cl. CPC B60R 22/20; B60N 2/688; B60R 22/26; B60R 2022/207; B60R 2022/208

(57) ABSTRACT

A seat belt positioning system and method built inside of a seat having a track configured to extend a seat belt horizontally and vertically; an extender arm coupled to the track; a shoulder adjustment trolley configured to move the seat belt in a lateral direction; and a control system operably connected to the track and the shoulder adjustment trolley.

### CROSS REFERENCE TO RELATED APPLICATIONS

This application claims priority to U.S. Provisional Patent Application 63/664,657 filed on Jun. 26, 2024 which is incorporated in its entirety.

### FIELD OF THE DISCLOSURE

The overall field of this invention relates to a seat belt positioning system built into a seat that makes a retracted seat belt easier for a user to grasp and more particularly a positioning system that has a track which extends the seat belt horizontally and vertically through a series of motions to provide the seat belt strap to the user.

### BACKGROUND

Current occupant safety systems in traditional one-, two-, or three-row vehicles, such as restraints like seat belts, are designed to reduce injury risk during a collision. Seat belts generally consist of a strap (either a shoulder or lap strap) and a buckle, which includes a latch and a receiver. When a vehicle occupant sits in the seat, they reach for the latch, pull the strap away from the seat, and insert the latch into the receiver, securing the strap around their body. Typically, seat belts have one or more anchors that attach the belts to the vehicle seat, guiding the strap's positioning on the occupant's body as the latch is inserted into the receiver. These anchors are usually fixed in place at predetermined locations on the seat which can be restrictive. Additionally, the strap may be hard to locate or may become dislodged. Thus exists the need for a new, smart seat belt system.

### SUMMARY

The present invention provides a seat belt positioning system that makes a retracted seat belt easier for a user to grasp. The system may be implemented into racing vehicles or traditional vehicles. The positioning system may have a track which extends the seat belt horizontally then vertically to exit the seat at an angle. The dual track system gives travel and includes a bearing carriage that travels smoothly, attached to the carriage there is a arched arm that provides precise travel to the user. The arched arm moves the belt closer to the person while the sprocket assembly with motor and wire provides power to the bearing up and down travel. In addition DC actuator motors can be used instead of a wire and sprocket system for each vertical track system. This may be used in combination with a shoulder adjustment trolley having a gear and rack system that moves the straps of the seat belt towards a user and away from a user in a lateral direction. A single DC actuator motor can be used to power both lateral movements in opposite directions.

In some aspects, the techniques described herein relate to a seat belt positioning system including: a track configured to extend a seat belt horizontally and vertically; an extender arm coupled to the track; a shoulder adjustment trolley configured to move the seat belt in a lateral direction; and a control system operably connected to the track and the shoulder adjustment trolley.

In some aspects, the techniques described herein relate to a seat belt positioning system, further including a sensor system in communication with the control system, wherein the sensor system is configured to detect at least one of: seat occupancy, door position, ignition status, or seat belt buckle engagement.

In some aspects, the techniques described herein relate to a seat belt positioning system, wherein the control system is configured to activate the track and the shoulder adjustment trolley in response to signals from the sensor system.

In some aspects, the techniques described herein relate to a seat belt positioning system, wherein the extender arm is configured to protrude from a portion of a vehicle seat when activated.

In some aspects, the techniques described herein relate to a seat belt positioning system, further including a motor system operably connected to the control system and configured to drive movement of the track and the shoulder adjustment trolley.

In some aspects, the techniques described herein relate to a seat belt positioning system, wherein the motor system includes at least one of: an electric motor, a stepper motor, a servo motor, or a pneumatic actuator.

In some aspects, the techniques described herein relate to a seat belt positioning system, wherein the shoulder adjustment trolley includes: at least one linear rail; at least one carriage configured to move along the linear rail; and a central gear mechanism configured to drive the carriage along the linear rail.

In some aspects, the techniques described herein relate to a seat belt positioning system, wherein the track includes: a vertical track; a rotational mechanism connected to the vertical track; and a bearing system configured to facilitate smooth movement along the vertical track.

In some aspects, the techniques described herein relate to a seat belt positioning system, further including a communication system configured to allow a user to remotely activate the seat belt positioning system.

In some aspects, the techniques described herein relate to a seat belt positioning system, wherein the extender arm is configured to receive the seat belt from the shoulder adjustment trolley and extend the seat belt toward a user.

In some aspects, the techniques described herein relate to a method of operating a seat belt positioning system including: detecting, via at least one sensor, a triggering event; activating, in response to the triggering event, a shoulder adjustment trolley to move a seat belt laterally; transferring the seat belt from the shoulder adjustment trolley to an extender arm; extending the extender arm along a track to position the seat belt in proximity to a user; and retracting, after detection of seat belt engagement, the extender arm and the shoulder adjustment trolley.

In some aspects, the techniques described herein relate to a method, wherein the triggering event includes at least one of: door opening, seat occupancy detection, or ignition activation.

In some aspects, the techniques described herein relate to a method, further including communicating status information to a remote computing device.

In some aspects, the techniques described herein relate to a vehicle restraint system including: a seat belt having a strap, a tongue mechanism and a latch mechanism; a positioning system connected to the seat belt, the positioning system including an extender arm configured to move the seat belt both horizontally and vertically; and a control system configured to control movement of the positioning system based on sensed vehicle conditions.

In some aspects, the techniques described herein relate to a vehicle restraint system, further including a lateral adjustment system configured to move the seat belt in a side-to-side direction before transferring the seat belt to the positioning system.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a schematic view of the smart seat belt system.

FIG. 2 is a system overview of the smart seat belt system.

FIG. 3 shows a detailed component view.

FIG. 4 shows a system view with control integration

FIG. 5 shows an operational view.

FIG. 6 shows detailed component specifications.

FIG. 7 shows the shoulder adjustment trolley.

FIG. 8 shows seat integration cross sections of the smart belt system.

FIG. 9 illustrates a front view of the smart belt system.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skills in the art to which this disclosure pertains.

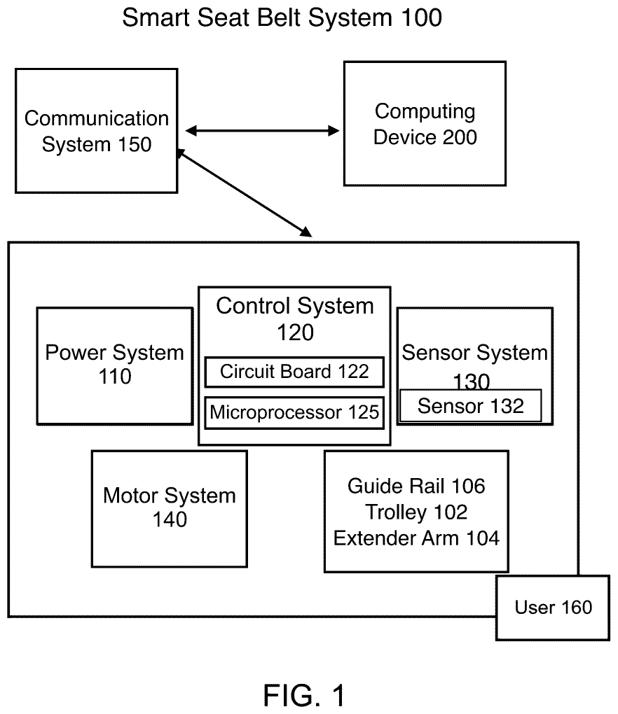

With reference to FIG. 1, there is an illustration for one possible embodiment of the smart seat belt system 100 that may be installed or otherwise integrated into a vehicle. A vehicle may refer to but not be limited to sedans, race cars, SUVs, hatchbacks, convertibles, coupes, minivans, cargo vans, passenger vans, pickup trucks, semi-trucks, dump trucks, tow trucks, or any other type or combination of a land, air, or water-based vehicle.

Smart seat belt system 100 may be adapted for aircraft applications, including commercial passenger aircraft, private jets, and helicopter installations. In aircraft embodiments, system 100 may be configured to account for different gravitational forces during takeoff, flight, and landing, and may integrate with aircraft-specific safety systems and emergency procedures.

Smart seat belt system 100 may be marine applications, smart seat belt system 100 may be modified for use in boats, yachts, and other watercrafts. Marine embodiments may include corrosion-resistant materials, waterproof electrical connections, and integration with marine safety equipment. The system may account for vessel motion and provide stability-enhanced positioning during rough sea conditions.

In autonomous vehicle applications, smart seat belt system 100 may operate without requiring user input, automatically positioning seat belts for passengers who may be sleeping, reading, or otherwise occupied during autonomous travel. The system may integrate with the vehicle's autonomous driving sensors and passenger detection systems to provide belt positioning.

The seat belt may be designed as a conventional seat belt for traditional travel and commute or a racing seat belt with a specialized safety harness designed for use in high-performance and competitive racing environments. The seat belt strap may be made from durable, high-strength webbing material, such as nylon or polyester, to withstand extreme forces and resist abrasion. The seat belt may have a 3-point, 4-point, 5-point, or 6-point configuration depending on the application. The seat belt may have a single strap or multiple straps on either side of the user that secure the user at several points on the body (shoulders, waist, and/or crotch area). The seat belt may utilize one or more secondary adjustable straps to ensure a snug and secure fit for different body sizes and shapes. The seat belt may be equipped with quick-release buckles for fast and easy unbuckling in case of an emergency. The seat belts may have padded components that fit over the strap, including around the shoulders and chest, to enhance comfort and reduce the risk of injury during a crash.

The seat belt may include a buckle that includes a first buckle portion or a tongue mechanism and a second buckle portion or a seat belt latch mechanism. The seat belt latch mechanism may be coupled or attached to a portion of a buckle anchor in a traditional seat or second strap in a racing car seat. The seat belt tongue is adapted to be inserted into the seat belt latch mechanism. The user may engage the seat belt tongue by gripping a portion of the seat belt strap. The user may move the seat belt tongue toward the seat belt latch mechanism and insert the tongue into the latch mechanism.

The seat belt latch mechanism is adapted to retain the seat belt tongue and to secure the seat belt tongue within the seat belt latch mechanism. As the seat belt tongue is inserted into the seat belt latch mechanism, the seat belt strap is positioned on the user's body. When the seat belt strap is positioned on the occupant's body and the seat belt tongue is secured within the seat belt latch mechanism, the seat belt strap acts as a restraint while the occupant is in the vehicle. The user may remove the seat belt tongue by disengaging a latch on the latch mechanism such as by clicking an actuator such as a button.

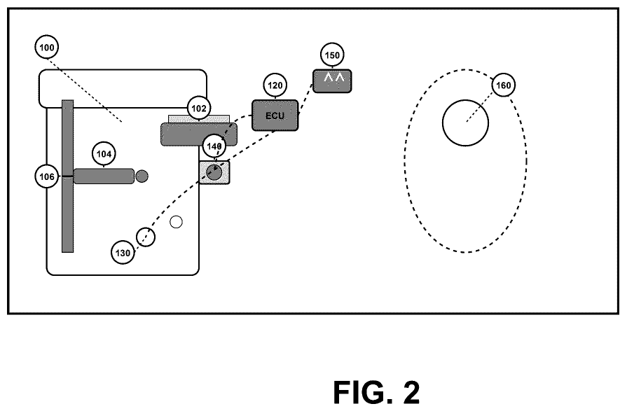

As, illustrated in the block diagram of FIG. 1 and FIG. 2, smart seat belt system 100 may include one or more components such as a shoulder adjustment trolley 102, a guide rail system 106 with an extender arm 104, a power system 110, a control system 120, a sensor system 130, motor system 140, and a communication system 150.

Power system 110 provides the power to circuits and components of control system 120, sensor system 130, motor system 140, and communication system 150 during application of smart seat belt system 100. Smart seat belt system 100 may be powered by methods known by those of ordinary skill in the art and may be powered and integrated into the operating system of the vehicle.

Control system 120 may operate to control the actuation of the other systems and may be integrated into the existing electronic control unit (ECU) of the vehicle or may be supplementary and connected to the ECU of the vehicle whereby the ECU and control system 120 may send and receive signals from one another. Control system 120 may have a series of computing devices. Control system 120 may be in the form of a circuit board, a memory or other non-transient storage medium in which computer-readable coded instructions are stored and one or more processors configured to execute the instructions stored in the memory. Control system 120 may have a wireless transmitter, a wireless receiver, and a related computer process executing on the processors.

Computing devices of control system 120, may be any type of computing device that typically operates under the control of one or more operating systems, which control scheduling of tasks and access to system resources. Computing devices may be a Raspberry Pi® or other computing devices such as but not limited to a phone, tablet, desktop computer, laptop computer, gaming system, networked router, networked switch, networked, bridge, or any computing device capable of executing instructions with sufficient processor power and memory capacity to perform operations of control system 120.

The one or more computing devices may be integrated into control system 120, while in other non-limiting embodiments, control system 120 may be a remotely located computing device or server configured to communicate with one or more other control systems. Control system 120 may also include an internet connection, network connection, and/or other wired or wireless means of communication (e.g., LAN, etc.) to interact with other components. The connection allows a user, such as user 160, to update, control, send/retrieve information, monitor or otherwise interact passively or actively with control system 120.

Control system 120 may include control circuitry and one or more microprocessors or controllers acting as a servo control mechanism capable of receiving input from sensor system 130, motor system 140, and communication system 150, analyzing the input from sensor system 130, motor system 140, and communication system 150, and generating an output signal to motor system 140. The microprocessors (not shown) may have on-board memory to control the power that is applied to power system 110, sensor system 130, motor system 140 and communication system 150 in response to input signals from the user 160 and from sensor system 130.

Control system 120 may have a circuit board 122 and may include a microcontroller 125 and a set of digital input/output (I/O) pins and analog input pins to connect to sensor system 130, communication system 150, and motor system 140.

Circuit board 122 may be powered through various sources, including USB connections, external power supplies, or batteries, depending on the specific board model. Microcontroller 125 may include a programming interface whereby a user may write code, upload it to microcontroller 125 via a USB connection, and execute the code on microcontroller 125. In further embodiments, circuit board 122 may be wireless having an antenna and a radio frequency module enables the circuit board 122 to communicate over radio frequencies for sending and receiving signals wirelessly.

Microcontroller 125 may include a clock crystal or oscillator to provide precise timing for microcontroller 125. Microcontroller 125 may include an onboard reset button allowing the user to restart circuit board 122 and reload new code. Circuit board 122 may include headers and connectors for easy attachment of hardware components, as well as shields which may be stacked on top of circuit board 122.

Control system 120 may include circuitry to provide an actuable interface such as for user 160 to interact with, including switches, buttons, and indicators and accompanying circuitry for an electronic control panel or mechanical control panel. Control system 120 may be preprogrammed with any reference values, by any combination of hardwiring, software, firmware to implement various operational modes including but not limited to temperature, light, and humidity values.

The microprocessors 125 in control system 120 may also monitor the current state of circuitry within control system 120 to determine the specific mode of operation chosen or needed for user 160. Further, such microprocessors that may be part of control system 120 may receive signals from any of or all systems, including without limitation, sensor system 130, motor system 140, power system 110, and communication system 150. Such systems may be notified whether any of the components in the various systems need to be replaced or the status of each of the sub-systems during operation of applying the seat belt to user 160.

Sensor system 130 may have a plurality of different sensors for different tasks. The sensors may be designed to determine that various actions have occurred, such as when the extender arm 104 or the shoulder adjustment trolley 102 are coupled or decoupled with the seat belt strap, the vehicle has been turned on, when the seat belt is connected or disconnected, when the door has been open or closed, or unlocked or locked. For instance, sensor system 130 may include a sensor 132 in the seat belt buckle, which functions as a proximity sensor or pressure sensor to detect the presence of the tongue of the first strap component has been positioned inside of the latch mechanism of the second strap component or when the tongue has been removed from the latch mechanism.

Sensor 132 may also be a micro-switch, which closes the circuit upon detecting the tongue inside of the latch mechanism. Alternatively, a magnetic sensor can detect the presence of the tongue inside of the latch mechanism through changes in the magnetic field. Sensor 132 can also be embodied in the form of any sensor that is well-known in the art. Similar concepts may be used for determining when the door has been shut or the key has been placed into the ignition or the ignition is activated by an actuator such as a push press button. The seat belt buckle, door, or ignition, may have wiring provided to couple the sensor 132 to a circuit board of control system 120, which is in turn coupled via a wiring to a motor and motor gear of motor system 140 that drives the components of smart seat belt system.

In one non-limiting embodiment, sensor system 130 may have infrared (“IR”) detectors having photodiodes and related amplification and detection circuitry. In other embodiments, radio frequencies, magnetic fields, and ultrasonic sensors, temperature sensors, pressure sensors, humidity sensors, or other types of sensors and transducers may be employed. Detectors may be arranged in any number of configurations and arrangements. Sensor system 130 may include one or more position sensors to monitor the position of extender arm 104 and shoulder adjustment trolly 102 and guide rail system 106 and ensure the components stop at the correct extension point.

Sensor system 130 may have one or more pressure plate sensors or additional pressure sensors or mechanical switches positioned on the seat belt buckle, door, or ignition, or inside other components of the vehicle such as the door or seat. The pressure plate sensors may have mechanisms for sensing pressure such as mechanical switches that are activated when enough force is applied, strain gauges that can measure the exact amount of force applied, or piezoelectric sensors that generate a voltage when pressure is applied, which can then be measured to determine the force. When pressure is applied to the pressure plate sensors, the plates generate a signal and sensor system 130 sends the signal to control system 120 to determine the appropriate action.

Communication system 150 may allow user 160 to interact with control system 120 using a computing device such as a remote computing device 200 or another user such as a crew chief to remotely activate smart seat belt system 100. User 160 may access a user interface with a plurality of buttons or icons that are selectable by user 160 for communication system 150 to perform particular processes in response to the selections such as turning on a specific mode or setting. In one or more non-limiting embodiments, communication system 150 may be innate, built into, or otherwise integrated into existing platforms or systems such as a website, a third-party program, Apple™ operating systems (e.g., iOS), Android™, Snapchat™, Instagram™ Facebook™, or any other platform. With the user interface, user 160 may set times where smart seat belt system 100 will always be functional or shut down.

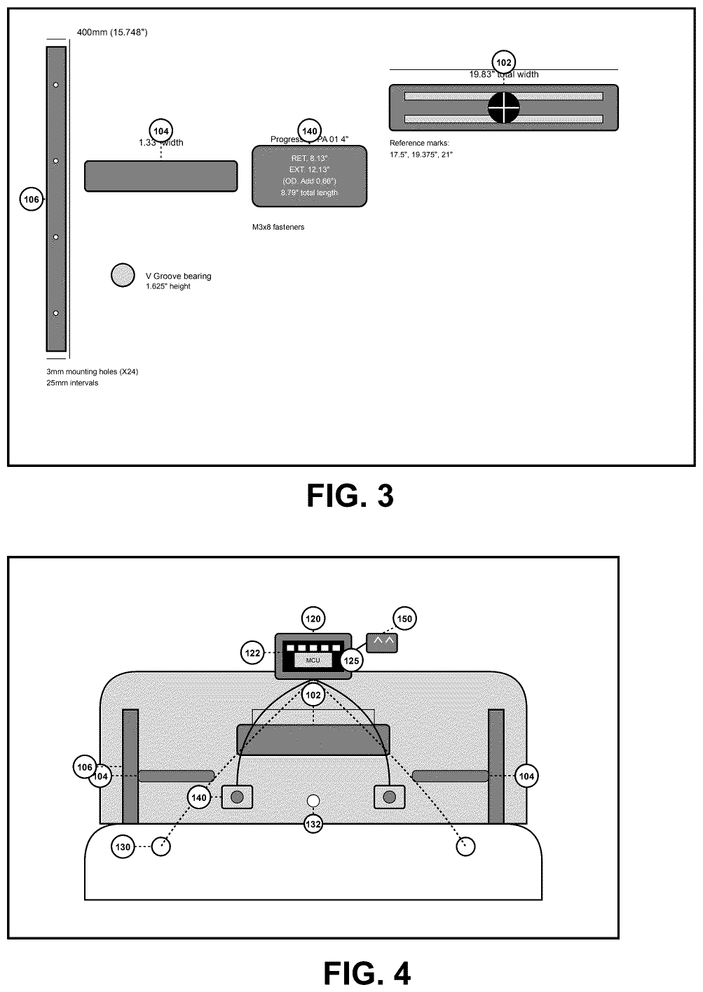

FIGS. 3 and 4 show the smart seat belt system 100 in a view of the individual components with precise dimensional specifications. Guide rail system 106 and extender arm 104 may be used for seat belt strap positioning, which rotates the seat belt strap outward and towards the vehicle occupant after shoulder adjustment trolley 102 delivers the strap to extender arm 104. In a traditional passenger car, there may be one guide rail system 106 and an extender arm 104 while in a race car there may be one or more guide rail systems 106 and extender arms 104 to deliver one or more straps to the user where they may buckle the straps together.

Guide rail system 106 may be positioned inside a hollow cavity of a seat of the vehicle. The seat may be in many forms such as a command chair or bench row. Guide rail system 106 may include brackets for secure attachment to the interior of the seat structure, ensuring stability and proper alignment during use. Guide rail system 106 may be made from a material such as steel or aluminum, ensuring durability and long-term performance. However, this is non-limiting and may be made of any suitable structure that does not stray from the intent of the present invention.

Guide rail system 106 may be implemented using a cable-driven positioning mechanism. The cable-driven positioning mechanism may include a series of cables, pulleys, and motorized winches that provide precise positioning of the seat belt strap through coordinated cable tension and release. This embodiment may be particularly advantageous in applications where weight reduction is critical, such as aircraft or racing vehicles.

In another embodiment, smart seat belt system 100 may utilize pneumatic actuators for positioning extender arm 104 and shoulder adjustment trolley 102. The pneumatic actuators may be powered by compressed air from the vehicle's existing pneumatic systems or from a dedicated air compressor. A magnetic levitation embodiment may employ magnetic positioning system comprising electromagnetic coils and permanent magnets to provide frictionless movement of extender arm 104 along guide rail system 106.

Smart seat belt system 100 may be integrated into vehicle seats through two primary implementation methods: original equipment manufacturer (OEM) integration during seat production, or aftermarket retrofitting of existing seats. For OEM integration, the guide rail system 106, shoulder adjustment trolley 102, and associated motor systems may be incorporated directly into the seat frame structure during manufacturing, with designated mounting points, wiring harnesses, and control interfaces built into the seat assembly or other known methods of fastening by those of ordinary skill in the art.

The seat cushioning and upholstery may be designed with predetermined access panels or flexible sections to accommodate the movement of extender arm 104 and the lateral motion of shoulder adjustment trolley 102. For retrofitting applications, smart seat belt system 100 may be adapted to existing vehicle seats through a modular installation process.

The retrofitting process may involve creating mounting brackets specifically designed to attach guide rail system 106 to the existing seat frame without compromising structural integrity. Retrofit installations may utilize the existing bolt patterns and mounting points of the original seat, with additional reinforcement brackets as needed to support the dynamic loads generated by the positioning system. The retrofit system may include seat cover modifications or replacement covers with integrated openings for extender arm 104 operation, ensuring that the aesthetic and functional characteristics of the original seat are maintained while adding the smart positioning functionality.

Both integration methods may incorporate vehicle-specific wiring harnesses that connect to the existing electrical systems, including power, ground, and communication interfaces with the vehicle's ECU. The modular design of smart seat belt system 100 allows for scalable implementation, from single-seat installations to complete vehicle conversions, with standardized components that may be adapted to various seat configurations including bucket seats, bench seats, and specialized racing seats.

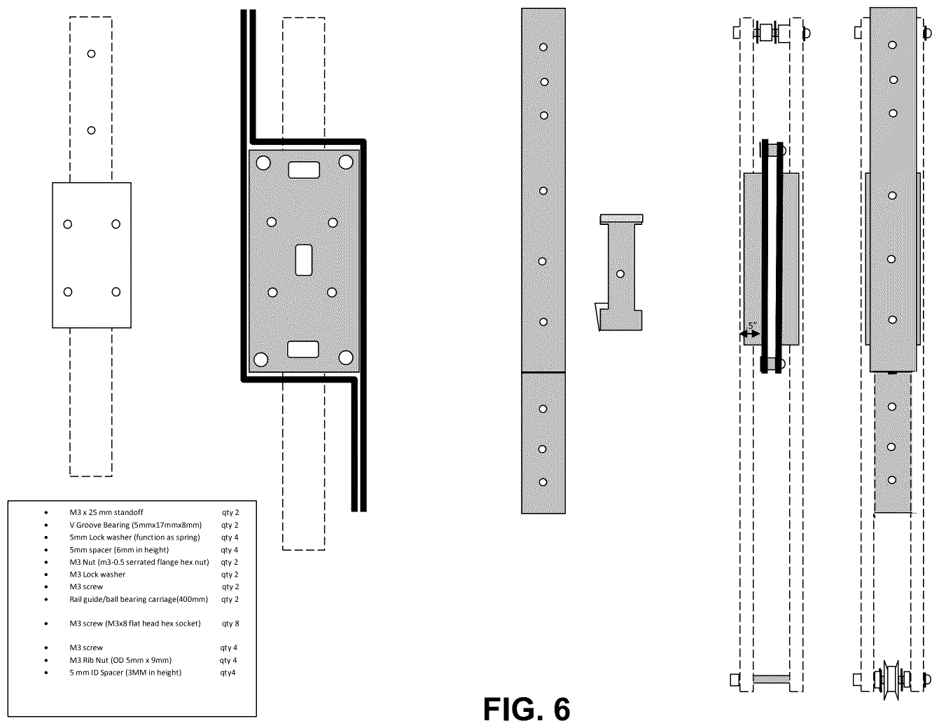

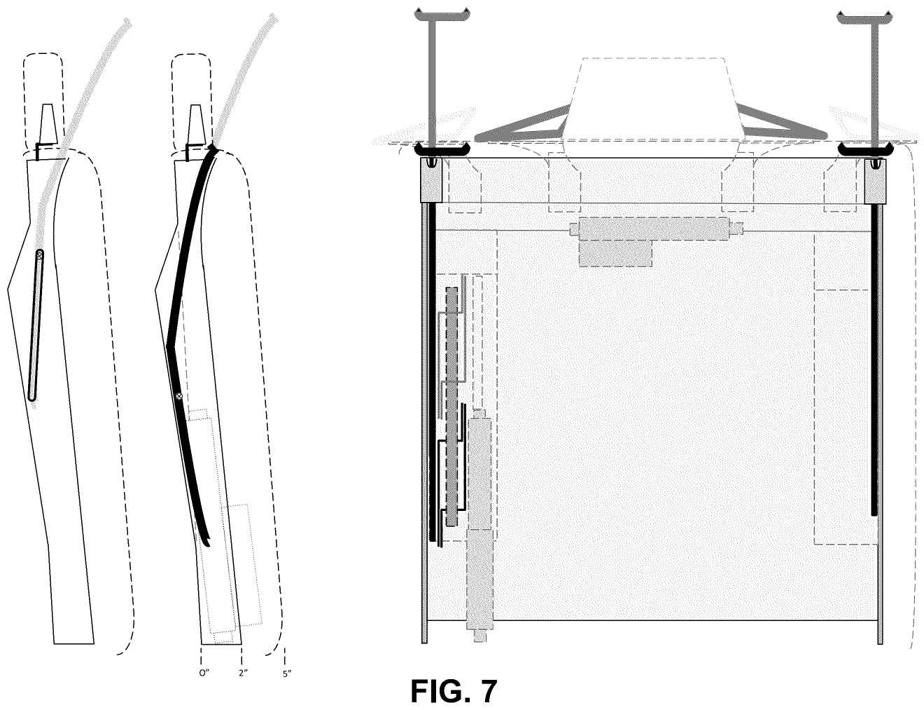

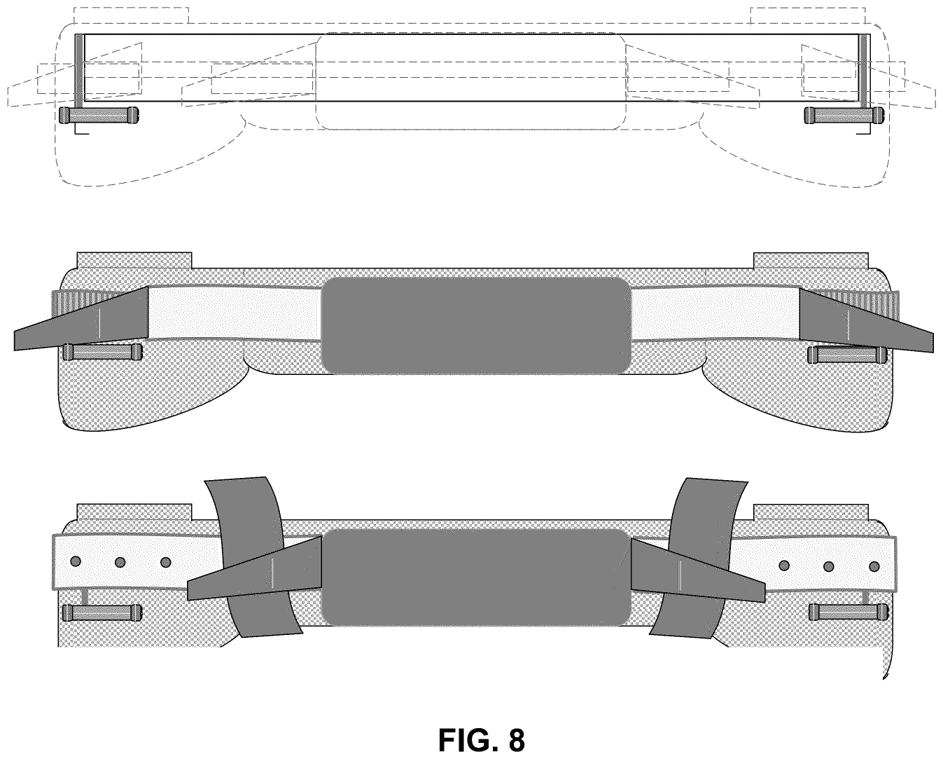

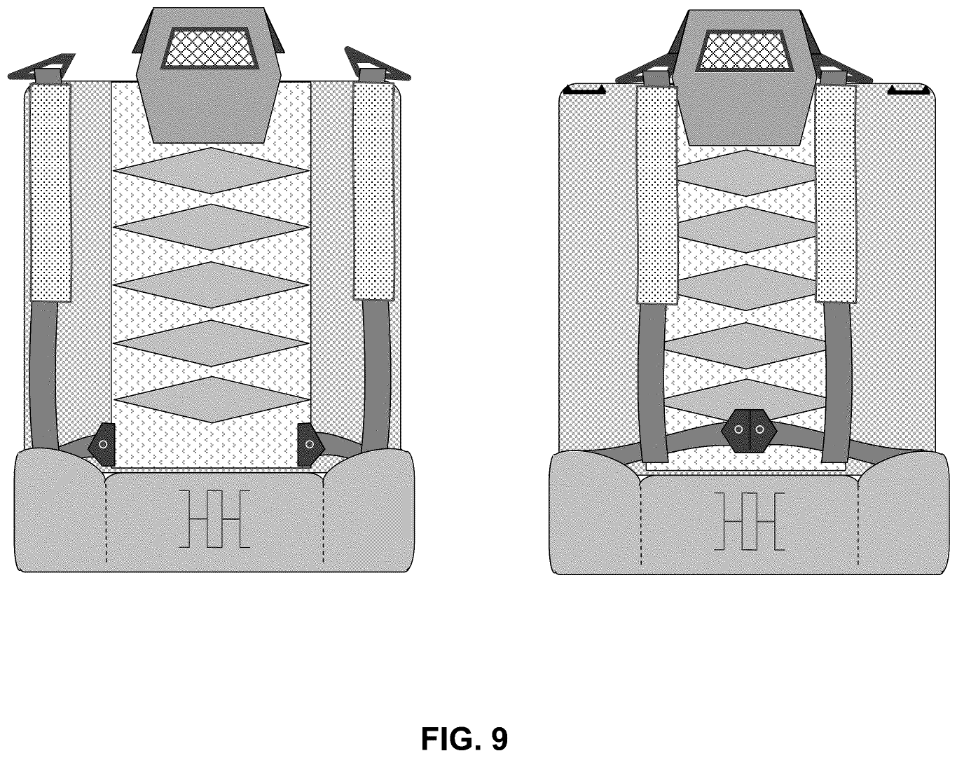

As shown in FIG. 6, the guide rail system 106 includes precise dimensioning for optimal functionality. The system utilizes both metric and imperial measurements, with key dimensions including:
a total width of 20 mm for the base mounting points
a vertical track with a height dimension of approximately 400 mm (15.748″)
3 mm mounting holes positioned at specific intervals of 0.394″, 1.378″, and 2.795″ from the reference point
5 mm mounting holes positioned at 0″, 0.727″, and 1.33″ from the reference point
M3 ribnut uniting both tracks with a 0.75″ horizontal spacing
Openings for M3 nut placement, positioned at three points along the vertical track
3 mm×4 countersunk mounting points for secure attachments

Guide rail system 106 may have one or more straight vertical tracks or rails with a machined surface to facilitate smooth movement. The vertical tracks have an elongated vertical length of 400 mm that allows for smooth and controlled rotational movement. The vertical tracks include circular and rectangular cross-sectional elements, with a series of channels to provide smooth movement.

Extender arm 104 may be connected to guide rail system 106 whereby extender arm 104 protrudes or extends partially or fully from the rear of the seat or a top surface of the seat. As shown in the drawings, extender arm 104 has precise dimensions with actuator attachment options (X6) positioned at intervals along its 1.33″ width frame. The extender arm includes belt extender arm attachment options (X6) for flexible configuration based on specific vehicle and user requirements. The arm is secured with M3 screws & lock washers, and includes 5 mm×3 mm spacers (X4) for proper alignment and operation.

The Progressive PA actuators come in two sizes as shown in the drawings:
Progressive PA 01 4″ with a retracted length of 8.13″ and an extended length of 12.13″ (with OD adding 0.66″ for a total length of 8.79″)
Progressive PA 01 6″ with a retracted length of 10.13″ and an extended length of 16.13″ (with OD adding 0.66″ for a total length of 16.79″)

The Progressive PA 01 actuator may have specific operational dimensions that define its movement range. In the standard 4″ model, the actuator measures 8.13″ in its retracted state and extends to 12.13″, with an outer diameter (OD) addition of 0.66″ for a total length of 8.79″. The actuator's operational parameters include extended positions of 17.83″ inside the track and 21.83″ outside of the track. Key reference points are positioned at 6.25″, 9.83″, and 13.83″ along the track, with a central section measuring 7.25″ between primary mounting points.

The eccentric nut and V groove bearing configuration used may essential for the metal wire pulley system. The V groove bearing is positioned at a precise height of 1⅝″ (1.625″) from the reference point, with the eccentric nut located 1.72″ from the base. This configuration enables smooth linear motion with minimal friction during operation. The track system has a total extended width of 21.83″ with intermediate reference points at 18.83″ and 13.83″.

The rail support structure may include precision-machined mounting rails with 3 mm mounting holes (X24) positioned at consistent 25 mm intervals. The rail assembly has a total length of 18.83″ with a central working section of 6.29″. Critical mounting points are positioned at heights of 0″, 0.25″, and 1.625″ from the base reference point. The system includes specific spacing measurements between component centers: 0.89″ center for lower mounting points and 1.315″ center for upper mounting points.

The guide components may have a 3 mm thickness (X3) profile design, featuring multiple 10 mm spacing measurements between mounting points. The components include 3 mm×4 countersunk mounting holes and 5.10 mm×7 mounting holes for attachment points. Critical dimensions include a height profile of 2.63″ and width measurements of 4.29″ for the upper portion and 3.29″ for the functional section. M3×8 fasteners secure the assembly at precisely measured intervals to ensure proper alignment and operational integrity.

Shoulder adjustment trolley 102, as illustrated in FIG. 3, may have one linear rail (traditional seat belt) or two linear rail guide rails (racing seat belt) with guide ways that are connected to a central gear for lateral adjustment of connected seat belt straps and provide linear movement along a defined path of the width of the seat. As shown in the drawings, the trolley system operates along a horizontal plane with dimensions indicating a 19.83″ total width. The system includes reference marks at 17.5″, 19.375″, and 21″ positions to ensure proper alignment during operation. The trolley system integrates with diamond-shaped support elements arranged in a cross-pattern for both structural integrity and comfort.

The carriages may be platforms that ride along the linear rails, supported by the guide bearings. The carriages may have mounting points or connection points for connecting to a length of the seat belt strap. The central gear may be a gear with teeth that mesh with a corresponding rack or drive mechanism to convert rotational motion into linear motion. The gear may be connected to one or more motors that are similar to the previously described motor of motor system 140 whereby the gear drives carriages along the one or more parallel linear rails. The gear may be connected to one or more with teeth that mesh with the drive gear, mounted parallel to the linear rails. The rails convert the rotational motion of the drive gear into linear motion, moving the carriage along the rails.

As discussed, the carriage may be connected to any number of electric motors, stepper motor, servo motor, pneumatic actuators, or manual levers of motor system 140 to provide necessary force to move the carriage along the linear track whereby motor system 140 may be connected to a metal wire pulley system. When activated, the motor may retract the metal wire, causing the carriage to move upward and the metal wire on the second component to travel upward to the extender arm and to rotate it along the rotational track.

The motor may be a high-torque AC or DC motor. A gearbox may be used to reduce the high-speed rotation of the motor to a lower speed with higher torque suitable for driving the carriage and may include worm gears, helical gears, or planetary gears. In some systems, chains or sprockets or belt drives may be used to transmit power from the motor to the carriage, and may be used for smoother and quieter operation. The motor may be connected to control system 120 which receives signals from sensor system 130 and then in return drives the carriage as well as regulates the speed and torque of the motor, using variable frequency drives (VFD) for AC motors or electronic speed controllers (ESC) for DC motors.

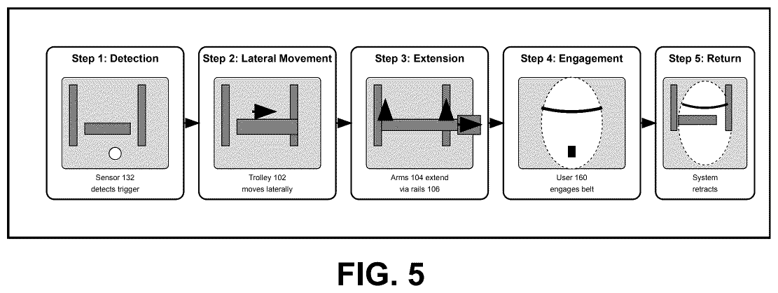

As illustrated in FIG. 5, when the motor or actuator is activated, the motor may provide rotational force to the drive gear. The speed, direction, and torque of the motor can be precisely controlled via control system 120. The teeth of the drive gear mesh with the corresponding teeth of the rack or a similar drive mechanism. As the gear rotates, it converts the rotational motion into linear motion, moving the carriage along the rails to the extender arm where the strap then couples with the extender arm. The carriage, supported by the linear rail guide bearings and guided by the guideways, moves along the linear rails. The motor may be controlled to stop at specific positions, change speed, or reverse direction.

During one method of operation, upon opening the door, the shoulder adjustment trolley opens outward carrying the attached seat belt strap with it as illustrated in FIG. 3. When the shoulder trolley hands off the belt to the extender arm. This will activate the sensor signaling the motion is ready to extend forward. When the seat pressure sensor detects a user's body 160, this will command the forward motion of the extender arm to start. When the seat belt has been removed from the extender arm and the buckle has been connected securing the person this will home both the extender arms and shoulder adjustment trolley back into the backrest providing a restraint to the user.

During another method of operation, upon the user unlocking the door and detecting seat pressure, the shoulder adjustment trolley opens outward carrying the attached belt with it. When the shoulder adjustment trolley hands off the belt to the extender arm, this will activate the sensor signaling it is ready to extend forward. When the seat pressure sensor detects a person's body weight, this will command the forward motion of the extender arm to start. When the belt has been removed from the extender arm and the buckle has been connected securing the person, this will home both the extender arms and shoulder adjustment trolley back into the backrest.

During a further method of operation, after the pressure sensor detects the user has sat down, and the ignition has been turned on, the shoulder adjustment trolley will begin to open outward carrying the attached belt strap with it. When the shoulder trolley hands off the belt to the extender arm, this sensor will command the arm to extend forward. When the belt has been removed from the extender arm and the buckle has been connected securing the person, this will home both the extender arms and shoulder adjustment trolley back.

Smart seat belt system 100 may include emergency safety features designed to protect user 160 during collision events. The emergency retraction system may include rapid retraction motors, emergency sensors, and collision detection circuitry. Upon detecting an imminent collision through emergency sensors, the emergency retraction system may immediately retract extender arm 104 and shoulder adjustment trolley 102 to prevent interference with airbag deployment or occupant movement during impact.

The emergency sensors may include accelerometers, gyroscopes, collision prediction sensors, or integration with the vehicle's existing airbag control module. A manual override system may be provided to allow user 160 or emergency personnel to manually operate smart seat belt system 100 in the event of power failure or system malfunction. Manual override system may include mechanical linkages, manual release handles, and bypass circuitry that disconnects motor system and allows direct manipulation of extender arm 104 and shoulder adjustment trolley 102.

Fire safety integration may include temperature sensors and heat-triggered mechanisms that automatically position the seat belt for rapid egress when elevated temperatures are detected. Temperature sensors may trigger emergency positioning mode when cabin temperature exceeds predetermined thresholds, facilitating faster evacuation.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A seat belt positioning system comprising: a track configured to extend a seat belt horizontally and vertically; an extender arm coupled to the track; a shoulder adjustment trolley configured to move the seat belt in a lateral direction; and a control system operably connected to the track and the shoulder adjustment trolley.

2. The seat belt positioning system of claim 1, further comprising a sensor system in communication with the control system, wherein the sensor system is configured to detect at least one of: seat occupancy, door position, ignition status, or seat belt buckle engagement.

3. The seat belt positioning system of claim 2, wherein the control system is configured to activate the track and the shoulder adjustment trolley in response to signals from the sensor system.

4. The seat belt positioning system of claim 1, wherein the extender arm is configured to protrude from a portion of a vehicle seat when activated.

5. The seat belt positioning system of claim 1, further comprising a motor system operably connected to the control system and configured to drive movement of the track and the shoulder adjustment trolley.

6. The seat belt positioning system of claim 5, wherein the motor system includes at least one of: an electric motor, a stepper motor, a servo motor, or a pneumatic actuator.

7. The seat belt positioning system of claim 1, wherein the shoulder adjustment trolley comprises: at least one linear rail; at least one carriage configured to move along the linear rail; and a central gear mechanism configured to drive the carriage along the linear rail.

8. The seat belt positioning system of claim 1, wherein the track comprises: a vertical track; a rotational mechanism connected to the vertical track; and a bearing system configured to facilitate smooth movement along the vertical track.

9. The seat belt positioning system of claim 1, further comprising a communication system configured to allow a user to remotely activate the seat belt positioning system.

10. The seat belt positioning system of claim 1, wherein the extender arm is configured to receive the seat belt from the shoulder adjustment trolley and extend the seat belt toward a user.

11. A method of operating a seat belt positioning system comprising: detecting, via at least one sensor, a triggering event; activating, in response to the triggering event, a shoulder adjustment trolley to move a seat belt laterally; transferring the seat belt from the shoulder adjustment trolley to an extender arm; extending the extender arm along a track to position the seat belt in proximity to a user; and retracting, after detection of seat belt engagement, the extender arm and the shoulder adjustment trolley.

12. The method of claim 11, wherein the triggering event comprises at least one of: door opening, seat occupancy detection, or ignition activation.

13. The method of claim 11, further comprising communicating status information to a remote computing device.

14. A vehicle restraint system comprising: a housing built into an existing seat behind a vehicle, a seat belt having a strap, a tongue mechanism and a latch mechanism; a positioning system connected to the seat belt, the positioning system comprising an extender arm configured to move the seat belt both horizontally and vertically; and a control system configured to control movement of the positioning system based on sensed vehicle conditions.

15. The vehicle restraint system of claim 14, further comprising a lateral adjustment system configured to move the seat belt in a side-to-side direction before transferring the seat belt to the positioning system.
